(19) United States
(12) Patent Application Publication
(10) Pub. No.: US 2016/0328766 A1
(43) Pub. Date: Nov. 10, 2016

(54) SHARING ECONOMY THIRD PARTY NOTIFICATION AND NEGOTIATION

(71) Applicant: FUJITSU LIMITED, Kawasaki-shi (JP)

(72) Inventor: Kevin KREJCI, San Francisco, CA (US)

(21) Appl. No.: 14/705,541

(22) Filed: May 6, 2015

(51) Int. Cl. G06Q 30/06; G06Q 50/26

(52) U.S. Cl. CPC G06Q 30/0609; G06Q 30/0645; G06Q 50/26

(57) ABSTRACT

A method of performing an electronic rental transaction includes obtaining, at a service provider server, an owner compliance from an owner device of an owner via a network. The method includes receiving, at the service provider server, an asset rental request from a customer for an asset of the owner. The method includes comparing, by one or more processors, customer permissions to rental conditions. The customer permissions include one or more disclosures that are authorized by the customer. The rental conditions include disclosures requested to rent the asset. In response to the customer permissions matching at least all of the rental conditions, the method includes approving an electronic rental transaction. In response to the customer permissions matching less than all the rental conditions, the method includes preventing the electronic rental transaction.

### FIELD

The embodiments discussed herein are related to sharing economy third party notification and negotiation.

### BACKGROUND

Recently, a sharing economy has developed in which individuals rent or loan assets in a peer-to-peer environment. The sharing economy may include or be referred to as a collaborative economy, a peer-to-peer (P2P) economy, on-demand economy, or collaborative consumption. In the sharing environment, assets owned by individuals may be made available for temporary use by other individuals. The temporary use may be in exchange for some monetary compensation or may be substantially free. The sharing economy may contribute to a collaborative consumption of resources in communities.

In some circumstances, specifics of agreements made in the sharing economy may be negotiated via a third-party platform. The third party platform may enable transparency in the transaction as well as a way in which individuals may list and/or access assets that are offered.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of performing an electronic rental transaction includes obtaining, at a service provider server, an owner compliance from an owner device via a network. The method may include receiving, at the service provider server, an asset rental request from a customer for an asset of the owner. The method may include comparing, by one or more processors, customer permissions to rental conditions. The customer permissions may include one or more disclosures that are authorized by the customer. The rental conditions may include disclosures requested to rent the asset. In response to the customer permissions matching at least all of the rental conditions, the method may include approving an electronic rental transaction. In response to the customer permissions matching less than all the rental conditions, the method may include preventing the electronic rental transaction.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example sharing economy environment (environment);

FIG. 2 illustrates a block diagram of an example process of effectuating participation of parties in an environment similar to the environment of FIG. 1;

FIG. 3 illustrates a block diagram of an example transaction process that may be implemented in an environment similar to the environment of FIG. 1;

FIG. 4 illustrates example customer permissions and example rental conditions;

FIG. 5 illustrates an example computing system that may be implemented in the environment of FIG. 1;

FIGS. 6A and 6B are a flow diagram of an example method of performing an electronic rental transaction;

FIG. 7 is a flow diagram of an example method of obtaining owner compliance; and

FIG. 8 is a flow diagram of an example method of registering a third party,

all arranged in accordance with at least one embodiment described herein.

### DESCRIPTION OF EMBODIMENTS

A sharing economy generally includes a first party who may offer an asset for use or may have authorization to offer the asset for use by a second party. As used herein, the first party is generally referred to as an owner and the second party is generally referred to as a customer. In addition to the owner and the customer, the sharing economy may include a third party. The third party may not be a direct owner of the asset but may have some association with the asset such that a use of the asset by the customer affects the third party. Generally, the third party may not receive any consideration for the effect the rental of the asset imposes on her. Additionally, in many cases, the owner is not available when the customer uses or accesses the asset, which may make communication between the owner and the third party difficult and introduces an additional imposition on the third party.

For example, the asset may be a condominium owned by the owner and the third party may be an owner of another condominium that shares an entrance with the condominium owned by the owner. When the customer is using the condominium owned by the owner, the third party may notice the presence of the customer, who may be a stranger. The third party may not know whether the customer is burglarizing the condominium owned by the owner, is a friend of the owner, or is a customer. Additionally, a code or key for the shared entrance may be provided to the customer, which may be seen as a security risk to the third party. While the owner may receive some consideration for use of the condominium, the third party often times does not. Moreover, the third party may not be aware of an agreement between the customer and the owner.

In addition, many jurisdictions are attempting to pass or have passed legislation related to the sharing economy. For example, transactions in the sharing economy may constitute taxable transactions that may be reported to governmental entities. Additionally, the sharing economy may change the nature of a community. For instance, in a rent-controlled apartment building, an owner may rent an apartment for less than a comparable hotel. However, in the aggregate, this behavior may transform the rent-controlled apartment building into a low-priced hotel. Accordingly, jurisdictions may regulate the sharing economy via an application process, registration process, and reporting.

To address these and other shortcomings, some embodiments described in this disclosure include a sharing platform. The sharing platform may provide transparency to transactions within the sharing economy. The transparency may include transparency between the owner, the customer, the third party, the government, or some combination thereof.

For example, the sharing platform may track conditions for a local jurisdiction (referred to in this disclosure as a “local zone”) for transactions in the sharing economy. The local zone conditions may be communicated to the owner, who may confirm compliance of the owner therewith prior to listing an asset on an application hosted or controlled by the sharing platform. In addition, the sharing platform may be configured to enable the owner and/or the third party to select rental conditions that are to be complied with by the customer to enter into a transaction involving the asset. The rental conditions may include disclosure of particular information concerning the customer and/or the transaction. For example, the rental conditions may include disclosure of a photo of the customer, a schedule of the use of the asset, and the like.

The sharing platform may further enable the customer to provide permission to disclose certain information (referred to as customer permissions) to one or more subsets of third parties or government entities by the sharing platform. For instance, the asset may include an apartment of the owner. The customer may provide permission to disclose, e.g., a photo to third parties who live in apartments that are immediately adjacent to the asset, a schedule of the use of the asset to a management party, and/or financial information to a governmental entity of the local zone. In some embodiments, in addition to information, the sharing platform may provide a secondary consideration (e.g., a percentage of a rental fee, a travel credit used with the sharing platform, a promotional offer, a coupon, a donation to a charity, etc.) to the third party.

Accordingly, in a transaction implemented using the sharing platform, prior to the customer renting the asset, the sharing platform may ensure that the customer permissions are at least equal to the rental conditions. If the customer permissions are not at least equal to the rental conditions, the transaction may be stopped by the sharing platform. The sharing platform may request that the customer provide additional permissions such that the customer permissions are at least equal to the rental conditions. If the customer permissions are at least equal to the rental conditions, the transaction may continue. After terms of the transaction are agreed to by the customer and the owner, the sharing platform may communicate information related to the customer and/or the transaction to the third party. Additionally or alternatively, the sharing platform may communicate information related to the customer and/or the transaction to one or more governmental entities.

The sharing platform may further enable customers and owners to effectively and securely connect with one another to negotiate transactions involving assets. The sharing platform may enable approval of reservation requests and/or enable the customer and the owner to share details about themselves through verified profiles and a secure communications system.

This and other embodiments are described with reference to the appended figures. In the figures, like numbers generally correspond to like structures unless indicated otherwise.

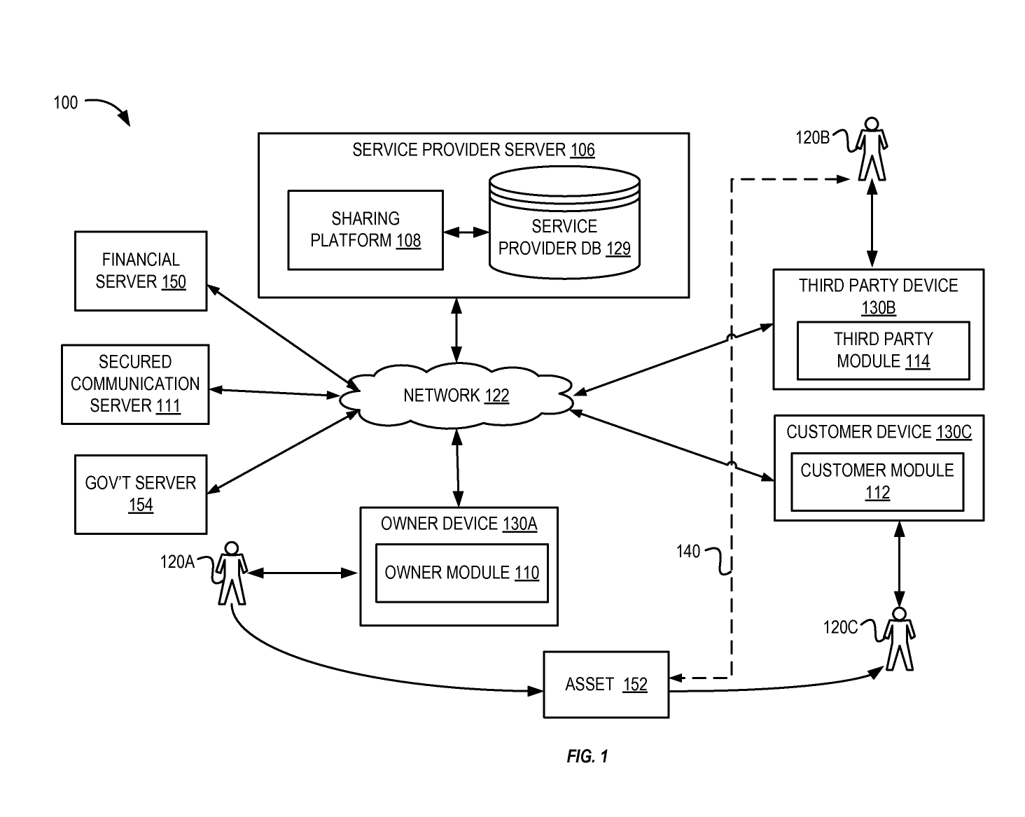

FIG. 1 illustrates an example sharing economy environment (environment) 100. In the environment 100, a service provider server 106 may enable an electronic rental transaction (transaction) between an owner 120A and a customer 120C that involves an asset 152. The transaction may include agreements, negotiations, transfers, etc., which are electronically communicated between the owner 120A and the customer 120C. Additionally, the transaction may include communication and/or compensation transmitted to a third party 120B who may have some association with the asset 152. The association between the third party 120B and the asset 152 is represented in FIG. 1 by dashed line 140.

The communication/compensation transmitted to the third party 120B may increase a level of transparency and involvement of the third party 120B in the transaction. By including the communication/compensation, the third party 120B may feel more secure with the transaction, issues that may arise during the transaction, and/or use by the customer 120C of the asset 152. Additionally, the compensation may monetarily or otherwise compensate the third party 120B for burdens imposed on the third party 120B because of the transaction and/or use by the customer 120C of the asset 152.

For example, the asset 152 may include a room at a home of the owner 120A. The customer 120C may be an individual who wants to rent the asset 152 for a particular term. The third party 120B may include a neighbor of the owner 120A. Renting of the room may impose upon the third party 120B. For instance, the home of the owner 120A may share a common area with a home of the third party 120B. Thus, the third party 120B may be interested to know information about the customer 120C or the transaction. The information may include, for example, a photo, contact information of the customer 120C, and the dates/time that the customer 120C is staying in the room. The third party 120B may accordingly be more comfortable with the customer 120C. In some embodiments, the third party 120B may additionally or alternatively receive financial compensation, another form of compensation such as travel credits, other information, or some combination thereof.

In the environment 100, the asset 152 may include any real property or personal property that may be rented or shared. Some examples of the asset 152 may include an apartment, a vacation rental, a condominium, a yacht, an automobile, a motorcycle, a bicycle, a boat, a vehicle, a room, and a piece of equipment. Additionally, in the environment 100, the transaction may include a short term or irregular term. For example, the transaction may include renting a room in a home for one night or renting a yacht for an afternoon.

In the environment 100 of FIG. 1, a financial server 150, the service provider server 106, a secured communication server 111, a government server 154 (in FIG. 1, “GOV'T SERVER”), and devices 130A-130C (generally, device 130 or devices 130) may communicate information and data via a network 122. Each of the financial server 150, the service provider server 106, the government server 154, the secured communication server 111, the devices 130, and the network 122 are briefly described below.

The network 122 may be wired or wireless. The network 122 may have numerous configurations including a star configuration, a token ring configuration, or another suitable configuration. Furthermore, the network 122 may include a local area network (LAN), a wide area network (WAN) (e.g., the Internet), and other interconnected data paths across which multiple devices may communicate. In some embodiments, the network 122 may include a peer-to-peer network. The network 122 may also be coupled to or include portions of a telecommunications network that may enable communication of data in a variety of different communication protocols. In some embodiments, the network 122 includes BLUETOOTH® communication networks and/or cellular communications networks for sending and receiving data including via short messaging service (SMS), multimedia messaging service (MMS), hypertext transfer protocol (HTTP), direct data connection, wireless application protocol (WAP), e-mail, etc.

The financial server 150 may include a hardware server that includes a processor, memory, and communication capabilities. In the illustrated embodiment, the financial server 150 may be communicatively coupled to the network 122 to send and receive data to and from the service provider server 106, the secured communication server 111, the government server 154, the devices 130, or some combination thereof.

The financial server 150 may be configured to interface with the service provider server 106 and the devices 130. Monetary compensation exchanged in a transaction may be drawn on an account via the financial server 150. For example, the customer 120C may agree to compensate the owner 120A a particular amount for rental of the asset 152. The service provider server 106 may interface with the financial server 150 to draw the particular amount from an account of the customer 120C and distribute the particular amount to accounts of the owner 120A and/or the third party 102B. The financial server 150 may be affiliated with a particular financial entity such as a bank or another payment enabling entity such as GOOGLE WALLET®, PAYPAL®, a bitcoin exchange, a peer-to-peer (P2P) exchange, and the like.

The government server 154 may include a hardware server that includes a processor, memory, and communication capabilities. In the illustrated embodiment, the government server 154 may be communicatively coupled to the network 122 to send and receive data to and from the service provider server 106, the secured communication server 111, the financial server 150, the devices 130, or some combination thereof.

The government server 154 may be configured to interface with the service provider server 106 and the devices 130. For example, monetary compensation exchanged in a transaction may be reported to the government server 154. Additionally, in some embodiments, a particular jurisdiction may receive owner applications from the owner 120A to participate in the environment 100. In these and other embodiments, the government server 154 may be configured to receive the owner applications, which may be communicated from and/or completed using the device 130.

In some embodiments, the government server 154 may be associated with a jurisdiction, which is referred to as a local zone. The government server 154 may communicate one or more local zone conditions. The local zone conditions may include legal requirements for the transactions. The legal requirements may include information to be communicated to the third party 120B, compensation percentages (e.g., 1% of a compensation paid by the customer 120C), governmental reporting conditions, and the like. The local zone conditions may be communicated to the service provider server 106 and/or the owner device 130A of the owner 120A.

The secured communication server 111 may include may include a hardware server that includes a processor, memory, and communication capabilities. In the illustrated embodiment, the secured communication server 111 may be communicatively coupled to the network 122 to send and receive data to and from the service provider server 106, the financial server 150, the government server 154, the devices 130, or some combination thereof.

The secured communication server 111 may act as an intermediary for secured communications between one or more of the service provider server 106, the financial server 150, the government server 154, the devices 130, or some combination thereof. The secured communication server 111 may be implemented to ensure the information that is sensitive is secured as it is communicated in the environment 100. For example, secured information such as tax information may be communicated between the parties 120 and the government server 154. Another example may include communication of credit card information between the devices 130 and the service provider server 106. An example of the secured communication server 111 may include a server operated by a third party communication company such as TWILIO®.

The owner 120A, the third party 120B, and the customer 120C (collectively, party 120 or parties 120) may include individuals or other entities that interact with the environment 100. Each of the parties 120 may be associated with one of the devices 130. For example, the owner 120A may be associated with the owner device 130A, the third party 120B may be associated with the third party device 130B, and the customer 120C may be associated with the customer device 130C. Associations between the devices 130 and the parties 120 may indicate that the parties 120 own the devices 130 or regularly operate the devices 130. Accordingly, data sent to and received from each party 120 may be sent to and received from the corresponding device 130 associated with the party 120.

In the embodiment shown in FIG. 1, the parties 120 are separated into the owner 120A, the customer 120C, and the third party 120B. In some embodiments, the roles (e.g., as an owner, a customer, or a third party) may not be limited to a single role in the environment 100. For example, the owner 120A may be a third party with reference to an asset, the third party 120B may be an owner with respect to an asset, the customer 120C may be a third party with respect to an asset, etc.

Generally, the devices 130 may enable interaction between the parties 120 and one or more of the financial server 150, the government server 154, other devices 130, and the service provider server 106. The devices 130 may each include a computing device that includes a processor, memory, and network communication capabilities. For example, the devices 130 may each include a laptop computer, a smart watch, a computing device implementing a virtual or augmented reality, a projected holographic display, a desktop computer, a tablet computer, a mobile telephone, a smart phone, a smart watch, a personal digital assistant (PDA), a mobile e-mail device, a portable game player, a portable music player, a television with one or more processors embedded therein or coupled thereto, or other electronic devices capable of accessing the network 122.

The owner device 130A may include an owner module 110, the customer device 130C may include a customer module 112, and the third party device 130B may include a third party module 114. The owner module 110, the customer module 112, and the third party module 114, may be collectively referred to as rental modules 110/112/114. In FIG. 1, the owner module 110, the customer module 112, and the third party module 114, are depicted as three separate modules. In some embodiments, the rental modules 110/112/114 or one or more functionalities attributed thereto may be included in more than three modules or fewer than three modules. For example, the rental modules 110/112/114 may be included in a single module or application. The single module may include all of the functionalities attributed in the present disclosure to the owner module 110, the third party module 114, and the customer module 112.

In general, the rental modules 110/112/114 enable interaction between the parties 120 and the service provider server 106 that may be involved in a transaction involving the asset 152. For example, the rental modules 110/112/114 may be used to solicit and effectuate participation of the parties 120. Additionally, the rental modules 110/112/114 may enable one or more of: the asset 152 to be listed at a website hosted or controlled by the service provider server 106, negotiations between the parties 120, accessing a listing of the asset 152, general communication between the parties 120, receipt of notifications related to the transaction, transfer of payment, or information disclosure among the parties 120.

In some embodiments, one of the functions of the customer module 112 may include reception of input from the customer 120C effective to select and modify customer permissions. The customer permissions include one or more disclosures that are authorized to be made to the third party 120B and/or to one or more subsets of third parties. The customer permissions may also include types of information related to the customer 120C that are authorized to be disclosed to the third party 120B and/or to one or more subsets of third parties. For example, the customer 120C may authorize sharing of general transactional information (e.g., dates, times, etc.) with the third party 120B, but may not authorize sharing of a photograph of the customer 120C with the third party 120B.

Additionally, in some embodiments, the owner module 110 may be configured to receive input that may be effective to select rental conditions. The rental conditions include one or more types of disclosures that may be requested to be shared in order to rent the asset 152. For example, the asset 152 may be an apartment. In this example, the rental conditions may include disclosure of a tax report to a governmental entity, disclosure of a schedule of use of the asset 152 to the third party 120B, and disclosure of a photograph of the customer 120C to the third party 120B. A prerequisite of a transaction in the environment 100 may be the customer 120C authorizing, via customer permissions of the customer 120C, disclosures included in the rental conditions. In circumstances in which the customer permissions do not include all of the rental conditions, the customer 120C may modify customer permissions of the customer 120C to coincide with or match rental conditions via the customer module 112.

One or more of the rental conditions may involve the third party 120B. For instance, in the example immediately above, disclosure of the photograph of the customer 120C and disclosure of the schedule may include disclosure to the third party 120B following completion of a transaction.

The rental modules 110/112/114 may include code and routines for transactions. In some embodiments, the rental modules 110/112/114 may act in part as a thin-client application that may be stored on a computing device, such as the devices 130, and in part as components that may be stored on the service provider server 106 or other server, for instance. In some embodiments, the rental modules 110/112/114 may be implemented using hardware including a processor, a microprocessor (e.g., to perform or control performance of one or more operations), a field-programmable gate array (FPGA) or an application-specific integrated circuit (ASIC). In some other instances, the rental modules 110/112/114 may be implemented using a combination of hardware and software. Implementation in software may include rapid activation and deactivation of one or more transistors or transistor elements such as may be included in hardware of a computing device (e.g., devices 130 and/or servers 106, 150, 154). Additionally, software defined instructions may operate on information within transistor elements. Implementation of software instructions may at least temporarily reconfigure electronic pathways and transform computing hardware.

The service provider server 106 may include a hardware server that includes a processor, memory, and communication capabilities. In the illustrated embodiment, the service provider server 106 may be coupled to the network 122 to send and receive data to and from the government server 154, the secured communication server 111, the financial server 150, the devices 130, or some combination thereof.

In the depicted embodiment, the service provider server 106 may include a sharing platform 108 and a service provider database (in FIG. 1, service provider DB) 129. The service provider database 129 may be configured to store some portion of information communicated in the environment 100. For example, the information may be related to the parties 120, the asset 152, local zone conditions accessed by the government server 154, financial information related to transactions and/or the parties 120, profiles of the parties 120, other information, or some combination thereof. The sharing platform 108 and the rental modules 110/112/114 may access the information stored on the service provider database 129 during negotiations or execution of a transaction in the environment 100.

In FIG. 1, the service provider database 129 may be included in the service provider server 106. In some embodiments, the service provider database 129 may be included in another server or computing system that is communicatively coupled to the service provider server 106. For example, in these embodiments, the service provider database 129 may be communicatively coupled to the service provider server 106 directly or via the network 122.

In general, the sharing platform 108 may be configured to enable a transaction relating to the asset 152 in the environment 100. For example, the sharing platform 108 may effectuate participation of the parties 120, host or control a website on which the listing of the asset 152 is accessible, notify the parties 120, transfer payment disclosure information to the parties 120, enable negotiations between the parties 120, and the like.

In addition, the sharing platform 108 may provide or host a website or application on which the customer 120C and the owner 120B effectively and securely connect with one another to negotiate transactions involving the asset 152. The sharing platform 108 may enable approval of reservation requests and/or enable the customer 120C and the owner 120A to share details about themselves through verified profiles and a secure communications system.

In some embodiments, the sharing platform 108 may be configured to obtain an owner compliance. The owner compliance may indicate that the owner 120A agrees to comply with local zone conditions in effect in the local zone in which the asset 152 exists. For example, the local zone may include a particular city (e.g., San Francisco) and the asset 152 may include a yacht. The particular city may require the disclosure of an insurance policy and certain identifying information of the customer 120C for short-term rentals of yachts secured within a common private marina. Accordingly, the sharing platform 108 may communicate the local zone conditions to the owner 120A, who may provide input via the owner module 110 that indicates that the owner 120A will comply with the local zone conditions when renting the asset 152.

The sharing platform 108 may be further configured to receive an asset rental request from the customer 120C for the asset 152. The sharing platform 108 may compare the customer permissions of the customer 120C to the rental conditions of the owner 120A. In response to the customer permissions matching at least all of the rental conditions, the sharing platform 108 may be configured to approve the transaction. When the transaction is approved, additional negotiations between the owner 120A and the customer 120C may be enabled, payment may be exchanged via the sharing platform 108, and/or notifications may be communicated to the parties 120.

In response to the customer permissions matching less than the rental conditions, the sharing platform 108 may be configured to prevent the transaction. In some embodiments, the sharing platform 108 may be further configured to communicate to the customer 120C a message requesting authorization of one or more additional types of information such that the customer permissions match at least all of the rental conditions. If the customer 120C modifies the customer permissions via the customer module 112, the sharing platform 108 may approve the transaction.

The sharing platform 108 may include code and routines for transactions. In some embodiments, the sharing platform 108 may be implemented using hardware including a processor, a microprocessor (e.g., to perform or control performance of one or more operations), a FPGA or an ASIC. In some other instances, the sharing platform 108 may be implemented using a combination of hardware and software. Implementation in software may include rapid activation and deactivation of one or more transistors or transistor elements such as may be included in hardware of a computing device (e.g., devices 130 and/or servers 106, 150, 154). Additionally, software defined instructions may operate on information within transistor elements. Implementation of software instructions may at least temporarily reconfigure electronic pathways and transform computing hardware.

Modifications, additions, or omissions may be made to the environment 100 without departing from the scope of the present disclosure. For example, the present disclosure applies to an environment 100 including one or more devices 130 that may be associated with one or more parties 120, one or more secured communication servers 111, one or more owners 120A, one or more customers 120C, one or more third parties 120B, one or more service provider servers 106, one or more government servers 154, one or more financial servers 150, one or more assets 152, or any combination thereof.

Moreover, the separation of various components in the embodiments described herein is not meant to indicate that the separation occurs in all embodiments. Additionally, it may be understood with the benefit of this disclosure that one or more of the described components may be integrated together in a single component or separated into multiple components.

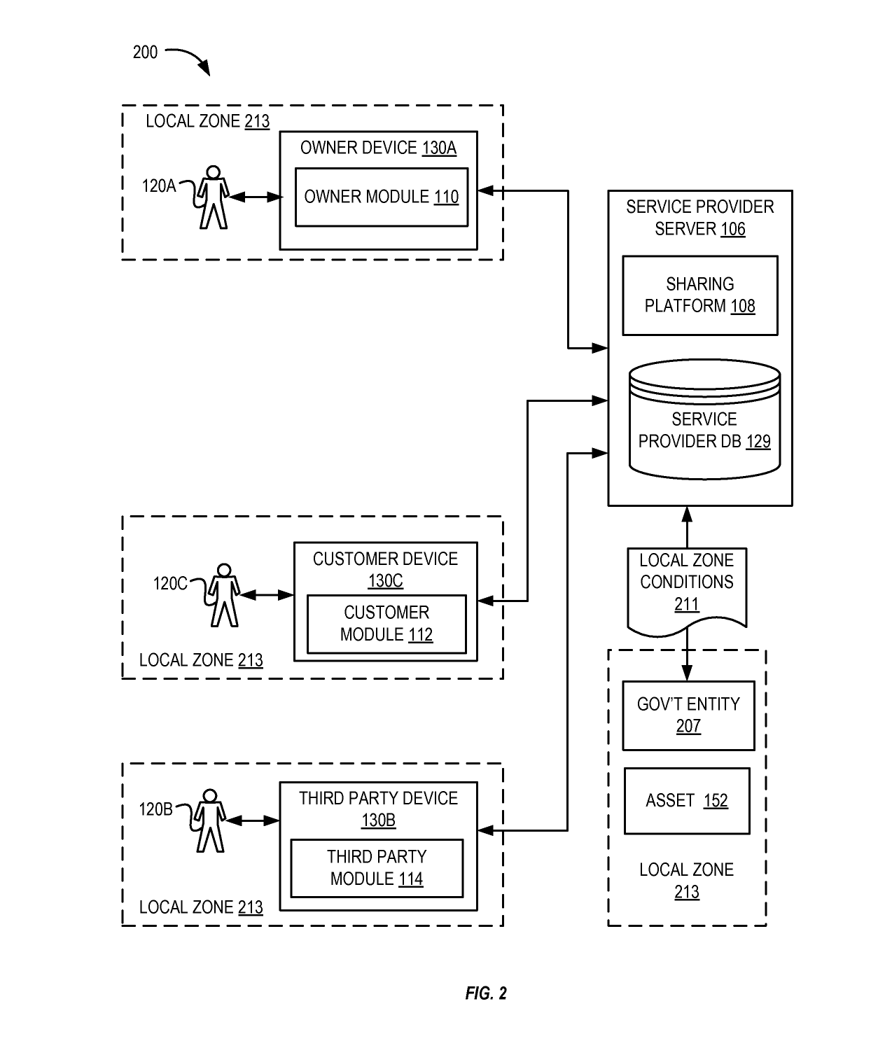

FIG. 2 illustrates a block diagram of an example process of effectuating participation of the parties 120 in an environment 200. The environment 200 is substantially similar to the environment 100 of FIG. 1, but omits the network 122, the financial server 150, the government server 154, and the dashed line 140 representing a relationship between the third party 120B and the asset 152. Although not depicted in FIG. 2, data and information communicated in the environment 200 may be via a network such as the network 122.

As discussed with reference to FIG. 1, transactions in the environment 200 may involve three parties 120: the owner 120A, the customer 120C, and the third party 120B. To execute a transaction in the environment 200, one or more of the parties 120 may agree to participate in the environment 200.

For example, to effectuate participation by the owner 120A the sharing platform 108 may obtain an owner compliance. In some embodiments, to obtain the owner compliance the sharing platform 108 may receive or access local zone conditions 211 from the governmental server 154. The local zone conditions 211 may be specific to a particular local zone 213. The local zone 213 may include a geographical or legal jurisdiction of the owner 120A, the third party 120B, the customer 120C, the asset 152, or some combination thereof.

The local zone conditions 211 may vary from a first local zone to a second local zone. Additionally, the local zone conditions 211 may vary from asset type to asset type. For instance, the local zone conditions 211 for renting an apartment in Washington, D.C. may be different from the local zone conditions 211 for renting a houseboat in San Francisco.

Moreover, one type of transaction may be subject to multiple local zone conditions 211. For example, a first local zone of the owner 120A may differ from a second local zone of the third party 120B. The first local zone may include a first local zone condition to report transactional proceeds to a first local government of the first local zone. Similarly, the second local zone may include a second local zone condition to report transactional proceeds to a second local government of the second local zone.

The sharing platform 108 may notify the owner 120A of the local zone conditions 211 via the owner module 110 of the owner device 130A. The owner 120A may review the local zone conditions 211 and determine whether to proceed with listing the asset 152 with the sharing platform 108. If the owner 120A decides to list the asset 152, then the owner 120A may provide input to the owner device 130A and/or the owner module 110. The input may be indicative of intent to comply with the local zone conditions 211 or may be indicative of a rejection of the local zone conditions 211.

In some embodiments, the input may be provided to a confirmation form, which may be communicated from the owner device 130A to the service provider server 106. The sharing platform 108 may receive the confirmation form and determine whether the owner 120A confirms compliance with the local zone conditions 211.

In response to the owner 120A confirming compliance with the local zone conditions 211, the sharing platform 108 may update a profile of the owner 120A in the service provider database 129 to reflect a confirmation of compliance with the local zone conditions 211. In response to the owner 120A not confirming compliance with the local zone conditions 211, the sharing platform 108 may suspend privileges of the owner 120A at least with respect to the asset 152. Suspension of the privileges may include prohibiting the owner 120A from listing the asset 152 and/or communicating with the customer 120C and/or the third party 120B via the sharing platform 108. Suspension of the owner 120A may be reflected in the service provider database 129.

In some embodiments, to effectuate participation by the third party 120B the sharing platform 108 may register the third party 120B. To register the third party 120B, the sharing platform 108 may notify the third party 120B of an intention of the owner 120A to list the asset 152 or of a current listing of the asset 152 with the service provider server 106. To notify the third party 120B, the sharing platform 108 may use received contact details of the third party 120B. For example, the owner 120A may communicate to the sharing platform 108 a list of the third parties (e.g., the third party 120B) who may be affected by rental of the asset 152. Additionally or alternatively, the contact details may be accessed or received from a governmental entity 207. For example, the contact details may be accessed from county records, business registrations, and the like.

The sharing platform 108 may offer to the third party 120B an option to receive information disclosure regarding the customer 120C in response to execution of a transaction involving the asset 152. Additionally or alternatively, the sharing platform 108 may offer to the third party 120B an option to receive a secondary consideration. The secondary consideration may include a portion of a primary consideration exchanged for rental of the asset 152, a travel credit, a promotional offer, a coupon, a bitcoin, a donation to a selected charity, or other types of consideration. Some additional details of the secondary consideration are provided elsewhere in this disclosure. The third party 120B may opt in to one or both of the offers.

In some embodiments, the offers may include an invitation and/or a link to download the third party module 114. For example, the offer to receive information disclosure may be communicated to an email address, a telephone number, a network address, or a physical address of the third party 120B. The offer may include a link to download the third party module 114, or other written instructions how to proceed.

The offer to receive the secondary consideration and/or the information disclosure may be communicated to the third party device 130B via the third party module 114. Additionally, future communications may be communicated to the third party 120B via the third party module 114.

In response to the third party 120B opting in to one or both of the offers, the sharing platform 108 may register the third party 120B. A registration of the third party 120B may be saved in the service provider database 129. Following registration of the third party 120B, when a transaction is executed involving the asset 152, the third party 120B may receive the information disclosure and/or the secondary consideration.

Participation by the customer 120C may be initiated by the customer 120C downloading the customer module 112 or otherwise accessing information and data stored or controlled by the service provider server 106. For example, the service provider server 106 may host and/or provide information to a website or mobile application that may be accessed by the customer 120C. When engaged with the environment 200, the customer 120C may select one or more customer permissions. Additionally, the customer 120C may provide personal information and/or demographic information to the service provider server 106. The personal information and/or demographic information may be stored in the service provider database 129 and associated with the customer 120C as a customer profile. Following creation of the customer profile, the customer 120C may view a rental listing of the asset 152 using the service provider server 106.

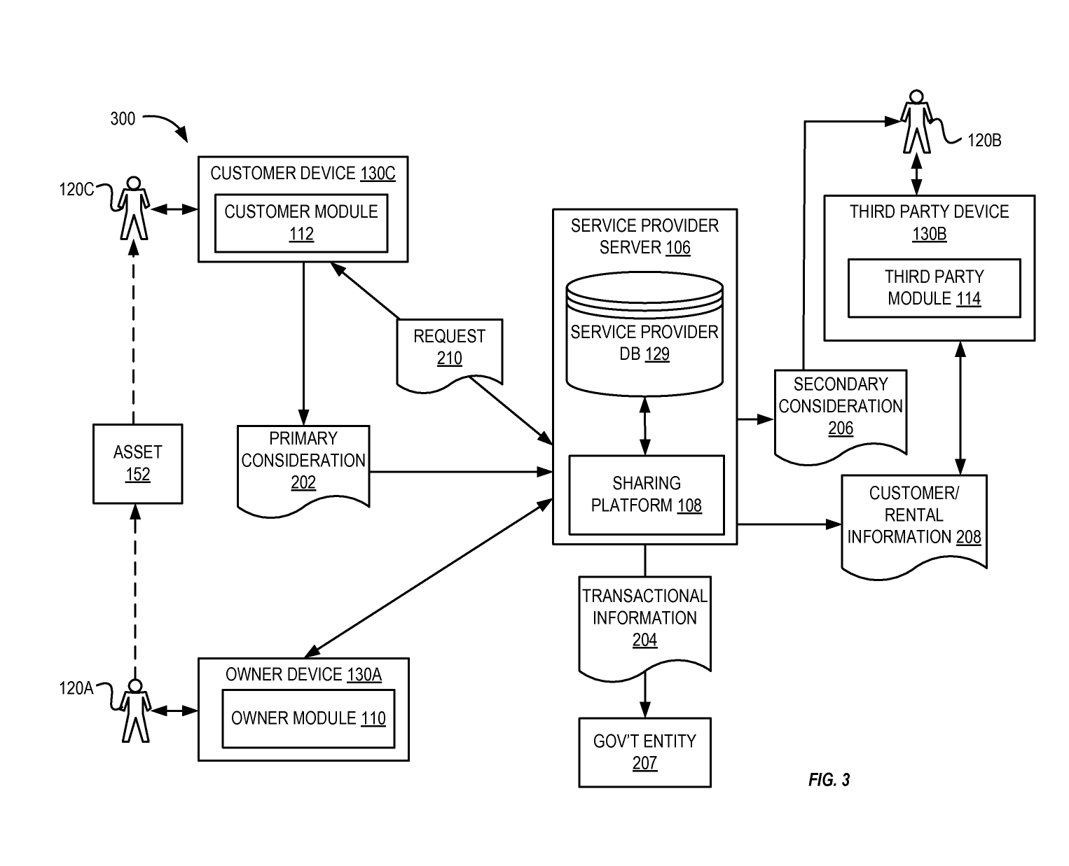

FIG. 3 illustrates a block diagram of an example transaction process that may be executed in an environment 300. The environment 300 is substantially similar to the environments 100 and 200 of FIGS. 1 and 2. The environment 300 omits one or more components of the environments 100 and/or 200. Although not depicted in FIG. 3, data and information communicated in the environment 300 may be via a network such as the network 122.

A transaction executed in the environment 300 may include reception of an asset rental request (in FIG. 3 “request”) 210 from the customer 120C or customer device 130C. The asset rental request 210 may include an initial inquiry as to availability and/or rental conditions associated with the asset 152.

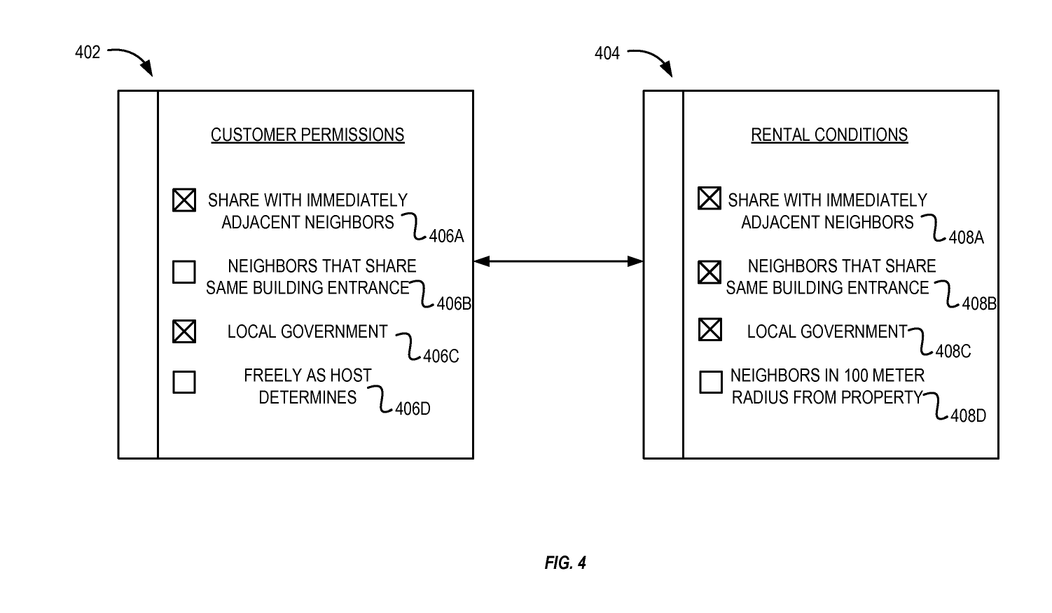

The sharing platform 108 may compare customer permissions to rental conditions. For example, with reference to FIG. 4, example customer permissions 402 and example rental conditions 404 are illustrated. The customer permissions 402 and the rental conditions 404 are examples that may be implemented in embodiments in which an asset (e.g., the asset 152) includes a rental property and third parties (e.g., the third party 120B) may include neighbors.

In the rental conditions 404, a first condition 408A (“SHARE WITH IMMEDIATELY ADJACENT NEIGHBORS”), a second condition 408B (“NEIGHBORS THAT SHARE SAME BUILDING ENTRANCE”), and a third condition 408C (“LOCAL GOVERNMENT”) are marked with an X. A fourth condition 408D (“NEIGHBORS IN 100 METER RADIUS FROM PROPERTY”) is not marked with an X. Marking the first, second, and third conditions 408A-408C may indicate that the first, second, and third conditions 408A-408C are obligatory for the rental of the asset. In some embodiments, one or more of the first, second, and third conditions 408A-408C may be local zone conditions (e.g., 211 of FIG. 2).

In the customer permissions 402, a first permission 406A (“SHARE WITH IMMEDIATELY ADJACENT NEIGHBORS”) and a third rental condition 406C (“LOCAL GOVERNMENT”) are marked with an X. A second condition 406B (“NEIGHBORS THAT SHARE SAME BUILDING ENTRANCE”) and fourth permission 406D (“FREELY AS HOST DETERMINES”) are not marked with an X. Marking the first and third permissions 406A and 406C may indicate that disclosures according to the first and the third permissions 406A and 406C are authorized.

The customer permissions 402 may be compared to the rental conditions 404. In the example depicted in FIG. 4, the customer permissions 402 do not include all of the rental conditions 404. Accordingly, a customer associated with the customer permissions 402 may not be allowed to rent an asset associated with the rental conditions 404. However, if the second permission 406B is marked, the customer permissions 402 may include all the rental conditions 404. Accordingly, the customer may be allowed to rent the asset. Additionally, if the fourth permission 406D is marked (even if the other permissions 406A, 406B, 406C are not marked), the customer permissions 402 may authorize more disclosure than those requested for rental of the asset. Accordingly, the customer may be allowed to rent the asset.

In addition to the customer permissions 402 and/or the rental conditions 404 of FIG. 4, the customer permissions 402 and/or the rental conditions 404 may include one or more of: transactional detail disclosure to a governmental entity, customer profile information disclosure to a set of third parties based on a geographic proximity to the asset, customer profile information disclosure to a set of third parties based on ownership of the asset, customer profile information disclosure to a set of third parties based on management of the asset, customer profile information disclosure to a set of third parties based on a common access point, a rental schedule to a set of third parties based on management of the asset, customer profile information disclosure to a set of third parties based on a membership related to the asset, other disclosures, or some combination thereof.

Referring back to FIG. 3, in response to the customer permissions matching at least all of the rental conditions of the asset 152 that is the subject of the request 210, the sharing platform 108 may approve a transaction. The transaction includes a transfer (e.g., in terms of use) of the asset 152 from the owner 120A to the customer 120C according to some terms.

In exchange for the transfer of the asset 152, the customer 120C may provide a primary consideration 202. In the depicted embodiment, the primary consideration 202 may be transferred to the service provider server 106. The primary consideration 202 or some portion thereof may be transferred to the owner 120A. For example, the primary consideration 202 may be transferred to the owner 120A via the owner device 130A and/or a financial server (e.g., the financial server 150 of FIG. 1). In some embodiments, the primary consideration 202 may be transferred directly to the owner 120A or via a credit card processing entity, cash payment processing entity, or the like.

In some embodiments, the sharing platform 108 may be further configured to communicate at least a portion of the negotiations between the customer 120C and the owner 120A. For instance, the negotiations may include offers and counter offers for price, rental term, and the like. The communications may be anonymous or partially anonymous, which may hide personal contact information of the owner 120A and/or the customer 120C.

During the rental transaction or following the rental transaction, the sharing platform 108 may notify a governmental entity 207. The notification communicated to the governmental entity 207 may be in accordance with the rental conditions and/or the local zone conditions. The notification communicated to the governmental entity 207 may include transactional information 204. Some examples of the transactional information 204 may include tax information related to the rental transaction, financial information related to the rental transaction, information related to a primary consideration 202 and/or a secondary consideration 206 (discussed elsewhere), and party information of the parties 120 included in the rental transaction. In some embodiments, the notification is communicated to the governmental entity 207 via a government server (e.g., the governmental server 154 of FIG. 1).

During the rental transaction or following the rental transaction, the sharing platform 108 may notify the third party 120B in accordance with the rental conditions and/or customer permissions. The notification communicated to the third party 120B may include customer/rental information 208. The customer/rental information 208 may include personal information of the customer 120C, a schedule related to the rental transaction, and other details related to the rental transaction.

The notification may be communicated to the third party device 130B according to a communication means selected by the third party 120B. For example, the notification may be communicated via an email, a MMS message, or the like. Additionally or alternatively, a link may be provided to the third party 120B. The link may open a webpage that includes the customer/rental information 208.

In addition to the customer/rental information 208, the sharing platform 108 may transfer a secondary consideration 206 to the third party 120B. In some embodiments, the transfer of the secondary consideration 206 may be via a financial server (e.g., the financial server 150 of FIG. 1) and/or via the third party module 114.

In some circumstances, which may depend on a type of the asset 152, there may be a delay between execution of a transaction and transfer of the primary consideration 202 and/or secondary consideration 206. For example, in embodiments in which the asset 152 includes a rental property, a payment may be sent to a financial entity at booking. However, the funds may not be distributed to the owner 120A until a rental duration begins. Thus, transfer of a primary consideration 202 to the owner 120A may be delayed. In addition, the secondary consideration 206 may not be transferred to the third party 120B until the payment is received by the owner 120A or even some time after receipt by the owner 120A.

In some embodiments, the secondary consideration 206 includes a portion of the primary consideration 202. For example, the secondary consideration 206 may include 0.5% of the primary consideration 202 or some other percentage or portion.

The primary consideration 202 and/or the secondary consideration 206 may be a monetary amount, for example currency. Additionally or alternatively, the primary consideration 202 and/or the secondary consideration 206 may include a travel credit that is exchanged in the context of the service provider server 106. The travel credit may be used in a transaction involving the asset 152 or another asset that is listed by the sharing platform 108. Additionally, the secondary consideration 206 may include a promotional offer for a commercial entity such as a travel website (e.g., EXPEDIA® or KAYAK®), a coupon that may be related the asset 152 (e.g., an airport shuttle coupon), a bitcoin, or a donation to a charity that may be selected by the owner 120A or the third party 120B, for instance.

For example, the secondary consideration 206 may include ten travel credits. The third party 120B may receive the ten travel credits each time the owner 120A rents the asset 152 to the customer 120C or another customer. The travel credits received by the third party 120B may accumulate. The third party 120B may then use the accumulated travel credits to rent the asset 152 or another asset listed on a website or application hosted by the sharing platform 108 without otherwise providing payment or at a reduced payment. In some embodiments, after the sharing platform 108 notifies the third party 120B and or transfers the secondary consideration 206 to the third party 120B, the sharing platform 108 may notify the owner 120A to confirm that a notification is communicated to a third party and/or the secondary consideration 206 is transferred to the third party 120B.

In FIG. 3, one transaction is depicted. In some embodiments, multiple transactions may be performed in the environment 300 involving the parties 120 and other parties as owners, customers, and third parties. The multiple transactions may overlap in duration. For instance, the owner 120A may receive the primary consideration 202 in exchange for renting the asset 152 to the customer 120C. At about the same time, the owner 120A may receive a secondary consideration for a transaction involving another asset and may be renting a third asset from another party.

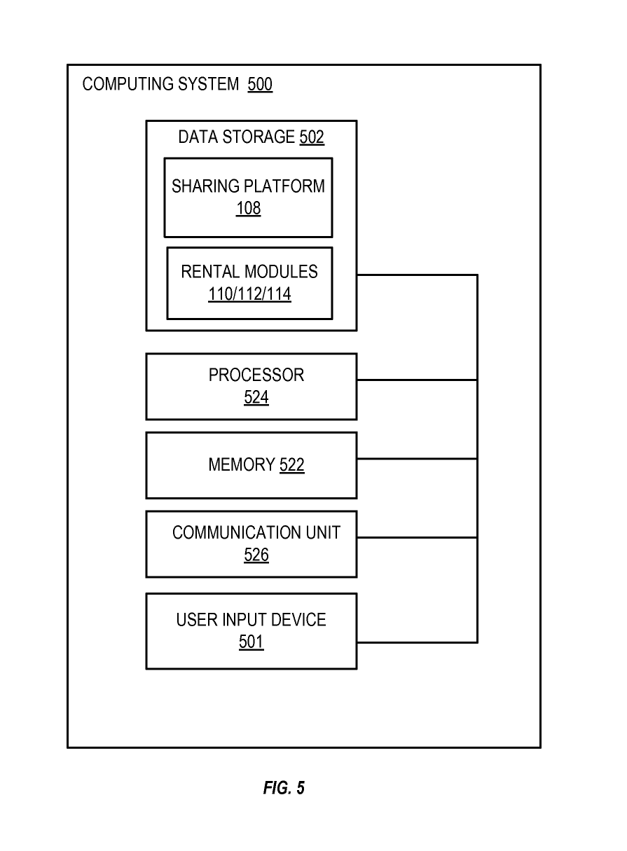

FIG. 5 illustrates an example computing system 500 that may be implemented in one or more of the environments 100, 200, and 300. The computing system 500 may be configured for transactions in a sharing economy environment such as the environments 100, 200, and 300. Examples of the computing system 500 may include one of the devices 130, the service provider server 106, the government server 154, and the financial server 150.

The computing system 500 may include one or more processors 524, a memory 522, a data storage 502 that includes the sharing platform 108 and one or more of the rental modules 110/112/114, a communication unit 526, and a user input device 501.

The processor 524 may include any suitable special-purpose or general-purpose computer, computing entity, or processing device including various computer hardware or software modules and may be configured to execute instructions stored on any applicable computer-readable storage media. For example, the processor 524 may include a microprocessor, a microcontroller, a digital signal processor (DSP), an ASIC, a FPGA, or any other digital or analog circuitry configured to interpret and/or to execute program instructions and/or to process data.

Although illustrated as a single processor in FIG. 5, the processor 524 may more generally include any number of processors configured to perform individually or collectively any number of operations described in the present disclosure. Additionally, one or more of the processors 524 may be present on one or more different electronic devices or computing systems. In some embodiments, the processor 524 may interpret and/or execute program instructions and/or process data stored in the memory 522, the data storage 502, or the memory 522 and the data storage 502. In some embodiments, the processor 524 may fetch program instructions from the data storage 502 and load the program instructions in the memory 522. After the program instructions are loaded into the memory 522, the processor 524 may execute the program instructions.

The memory 522 and data storage 502 may include computer-readable storage media for carrying or having computer-executable instructions or data structures stored thereon. Such computer-readable storage media may include any available media that may be accessed by a general-purpose or special-purpose computer, such as the processor 524. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 524 to perform a certain operation or group of operations.

The communication unit 526 may include one or more pieces of hardware configured to receive and send communications. In some embodiments, the communication unit 526 may include one or more of an antenna, a wired port, and modulation/demodulation hardware, among other communication hardware devices. In particular, the communication unit 526 may be configured to receive a communication from outside the computing system 500 and to present the communication to the processor 524 or to send a communication from the processor 524 to another device or network.

The user input device 501 may include one or more pieces of hardware configured to receive input from and/or provide output to a user. In some embodiments, the user input device 501 may include one or more of a speaker, a microphone, a display, a keyboard, and a touch screen, a holographic projection, among other hardware devices. In these and other embodiments, the user input device 501 may be configured to receive input from a user (e.g., one of the parties 120) of the computing system 500.

The sharing platform 108 and/or the rental modules 110/112/114 may include program instructions stored in the data storage 502. The processor 524 may be configured to load the sharing platform 108 and/or the rental modules 110/112/114 into the memory 522 and execute the sharing platform 108 and/or the rental modules 110/112/114. Alternatively, the processor 524 may execute the sharing platform 108 and/or the rental modules 110/112/114 line-by-line from the data storage 502 without loading them into the memory 522. When executing the sharing platform 108 and/or the rental modules 110/112/114, the processor 524 may be configured to perform operations included in transactions of a sharing economy as described elsewhere herein.

Modifications, additions, or omissions may be made to the computing system 500 without departing from the scope of the present disclosure. For example, in some embodiments, the computing system 500 may not include the user input device 501. In some embodiments, the different components of the computing system 500 may be physically separate and may be communicatively coupled via any suitable mechanism. For example, the data storage 502 may be part of a storage device that is separate from a server, which includes the processor 524, the memory 522, and the communication unit 526, that is communicatively coupled to the storage device.

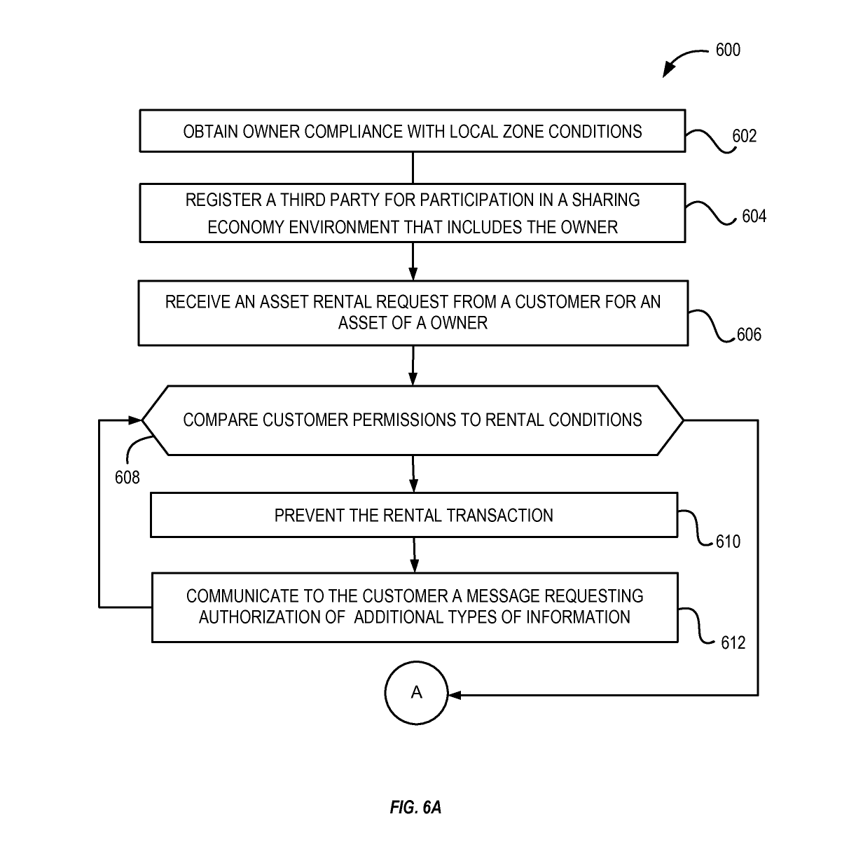

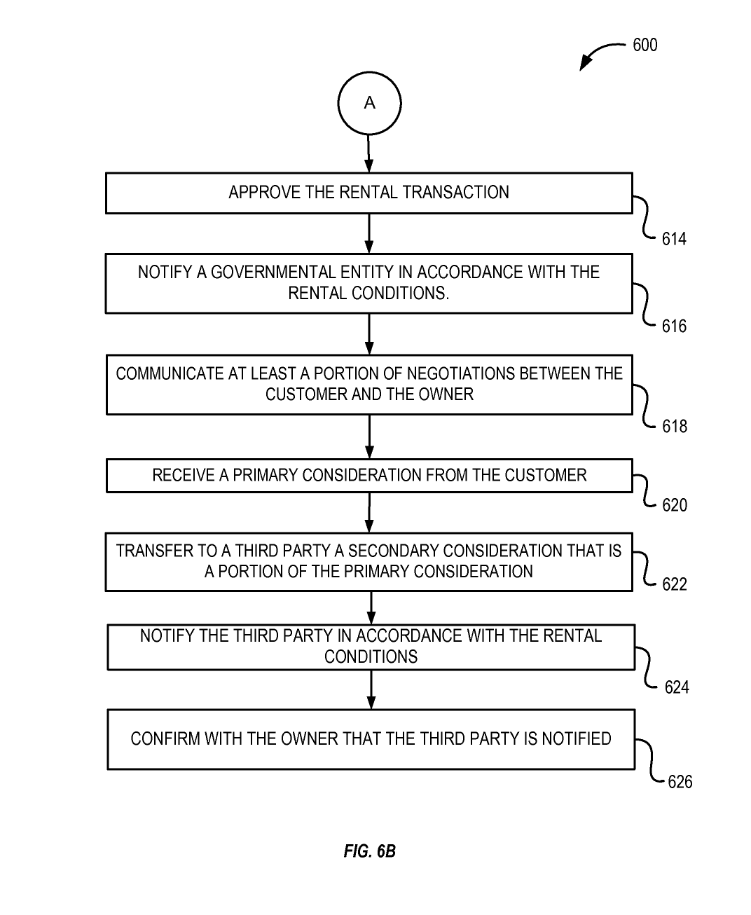

FIGS. 6A and 6B are a flow diagram of an example method 600 of performing a rental transaction, arranged in accordance with at least one embodiment described herein. The method 600 may be programmably performed in whole or in part in some embodiments by a computing system such as the computing system 500 of FIG. 5, one or more of the devices 130, the service provider server 106, or some component of any of the foregoing. In some embodiments, the computing system may include or may be communicatively coupled to a non-transitory computer-readable medium (e.g., the memory 522 of FIG. 5) having stored thereon programming code or instructions that are executable by a processor (such as the processor 524 of FIG. 5) to cause the computing system to perform or control performance of the method 600. Additionally or alternatively, the computing system may include the processor 524 that is configured to execute computer instructions to cause the computing system or a component thereof to perform or control performance of the method 600. Although illustrated as discrete blocks, various blocks may be divided into additional blocks, combined into fewer blocks, or eliminated, depending on the desired implementation.

With reference to FIG. 6A, the method 600 may begin at block 602. At block 602, an owner compliance with one or more local zone conditions may be obtained. The owner compliance may be received at a service provider server such as the service provider server 106 described in this disclosure. At block 604, a third party may be registered for participation in a sharing economy environment that includes the owner. At block 606, an asset rental request may be received from a customer for an asset of the owner. In some embodiments, the asset rental request may be received at a service provider server such as the service provider server 106.

At block 608, customer permissions may be compared to rental conditions. In some embodiments, the customer permissions may be compared to the rental conditions by one or more processors. The customer permissions may include one or more disclosures that are authorized by the customer and the rental conditions may include disclosures requested to rent the asset.

In response to the customer permissions matching less than all the rental conditions, the method 600 may proceed to block 610. In response to the customer permissions matching at least all of the rental conditions, the method 600 may proceed to block 614 in FIG. 6B.

At block 610, the rental transaction may be prevented. At block 612, a message may be communicated to the customer. The message may request authorization of one or more additional disclosures such that the customer permissions match at least the rental conditions. The method 600 may return to block 608 following block 612 and/or following modification by the customer of the customer permissions.

With reference to FIG. 6B, at block 614, the rental transaction may be approved. At block 616, a governmental entity may be notified in accordance with the rental conditions. At block 618, at least a portion of the negotiations between the customer and the owner are communicated. For example, at least a portion of the negotiations may be communicated via the network 122, the devices 130, the service provider server 106, or some combination thereof. The at least the portion of the negotiations may be communicated to the owner from the customer and from to the customer from the owner.

At block 620, a primary consideration may be received. The primary consideration may be transferred from the customer to the owner in exchange for use or rental of the asset. At block 622, a secondary consideration may be transferred to a third party. The secondary consideration may include a portion of the primary consideration (e.g., 0.5% of the primary consideration, a travel credit, a promotional offer, a coupon, a bitcoin, a donation to a charity, or some combination thereof). At block 624, the third party may be notified in accordance with the rental conditions. At block 626, it may be confirmed with the owner that the third party is notified.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

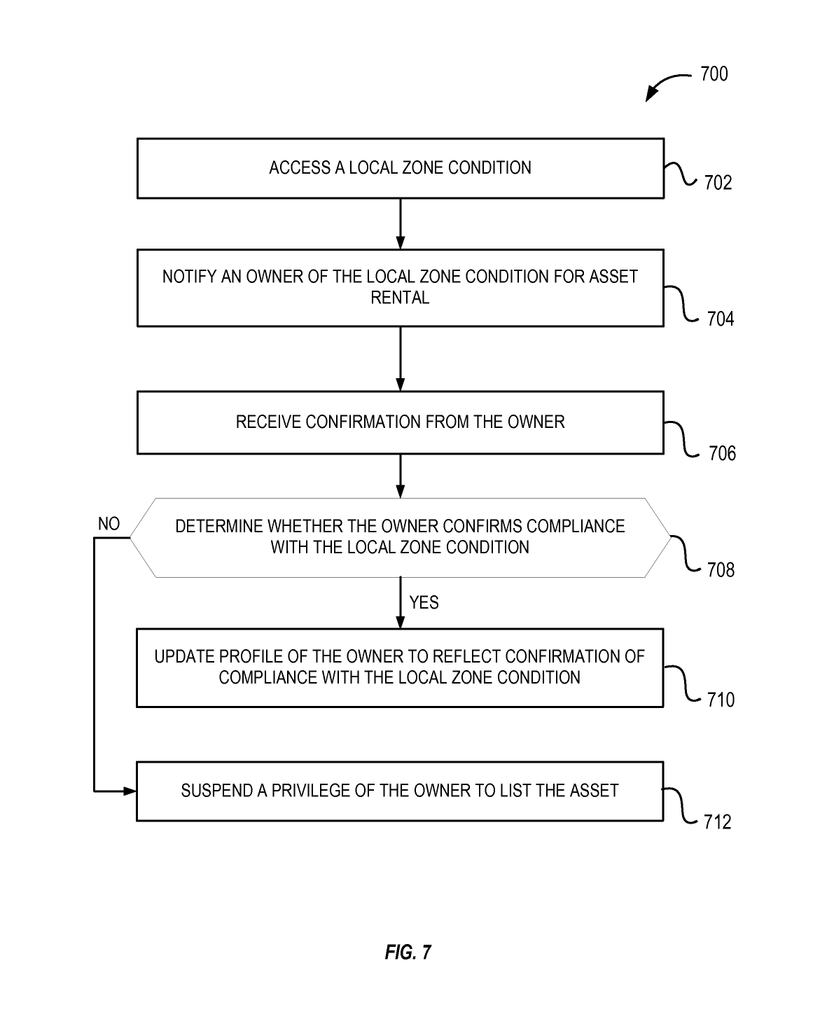

FIG. 7 is a flow diagram of an example method 700 of obtaining owner compliance, arranged in accordance with at least one embodiment described herein. The method 700 may be programmably performed in whole or in part in some embodiments by a computing system such as the computing system 500 of FIG. 5, one or more of the devices 130, the service provider server 106, or some component of any of the foregoing. In some embodiments, the computing system may include or may be communicatively coupled to a non-transitory computer-readable medium (e.g., the memory 522 of FIG. 5) having stored thereon programming code or instructions that are executable by a processor (such as the processor 524 of FIG. 5) to cause the computing system to perform or control performance of the method 700. Additionally or alternatively, the computing system may include the processor 524 that is configured to execute computer instructions to cause the computing system or a component thereof to perform or control performance of the method 700. Although illustrated as discrete blocks, various blocks may be divided into additional blocks, combined into fewer blocks, or eliminated, depending on the desired implementation.

The method 700 may begin at block 702 in which a local zone condition may be accessed. For example, the local zone condition may be accessed via a network such as the network 122. At block 704, the owner may be notified of the local zone condition for an asset rental. At block 706, a confirmation may be received from the owner. For example, a confirmation may be received at a service provider server such as the service provider server 106 via the network. At block 708, it may be determined whether the owner confirms compliance with the local zone condition.

In response to a determination that the owner confirms compliance with the local zone condition (“YES” at block 708), the method 700 may proceed to block 710. In response to a determination that the owner does not confirm compliance with the local zone condition (“NO” at block 708), the method 700 may proceed to block 712. At block 710, a profile of the owner may be updated to reflect the confirmation of compliance with the local zone condition. At block 712, a privilege of the owner to list the asset may be suspended.

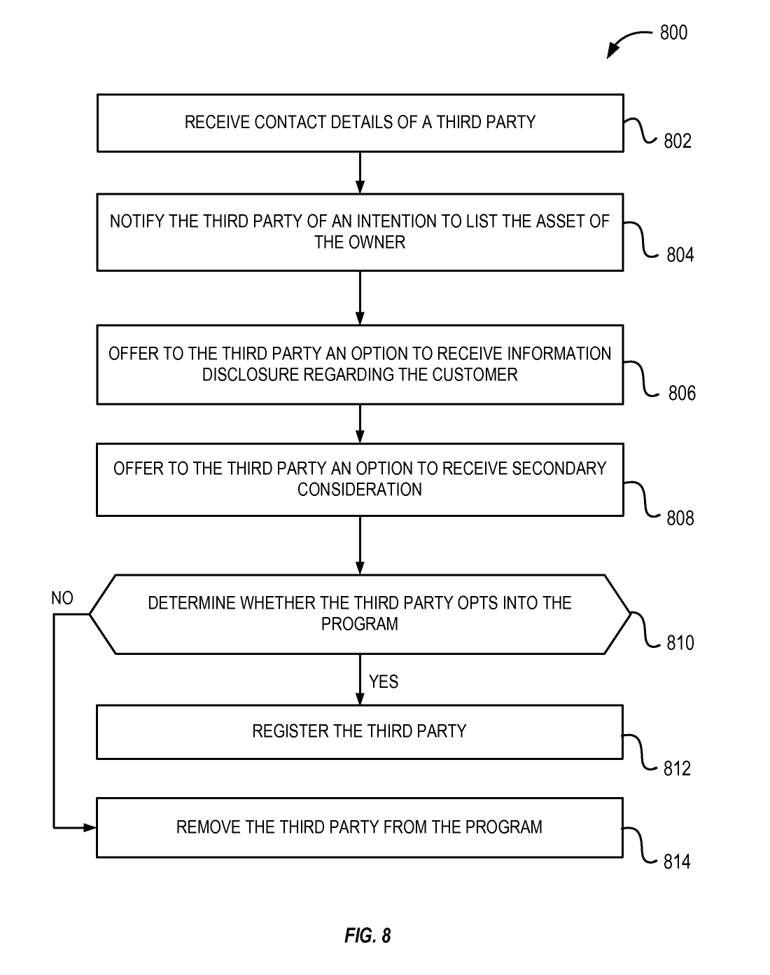

FIG. 8 is a flow diagram of an example method 800 of obtaining owner compliance, arranged in accordance with at least one embodiment described herein. The method 800 may be programmably performed in whole or in part in some embodiments by a computing system such as the computing system 500 of FIG. 5, one or more of the devices 130, the service provider server 106, or some component of any of the foregoing. In some embodiments, the computing system may include or may be communicatively coupled to a non-transitory computer-readable medium (e.g., the memory 522 of FIG. 5) having stored thereon programming code or instructions that are executable by a processor (such as the processor 524 of FIG. 5) to cause the computing system to perform or control performance of the method 800. Additionally or alternatively, the computing system may include the processor 524 that is configured to execute computer instructions to cause the computing system or a component thereof to perform or control performance of the method 800. Although illustrated as discrete blocks, various blocks may be divided into additional blocks, combined into fewer blocks, or eliminated, depending on the desired implementation.

The method 800 may begin at block 802 in which contact details of a third party may be received. In some embodiments, the contact details may be input by the owner, the service provider, or a governmental entity. At block 804, the third party may be notified of an intention to list the asset of the owner. At block 806, the third party may be offered an option to receive information disclosure regarding the customer in response to execution of a rental transaction involving the asset. At block 808, the third party may be offered an option to receive secondary consideration. In some embodiments, the secondary consideration may include a portion of a primary consideration that is exchanged between the owner and the customer for rental of the asset.

In response to the third party opting in (“YES” at block 810), the method 800 may proceed to block 812. In response to the third party not opting in (“NO” at block 810), the method 800 may proceed to block 814. At block 812, the third party may be registered. At block 814, the third party may be removed from a sharing economy environment.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including RAM, ROM, EEPROM, CD-ROM or other optical disk storage, magnetic disk storage or other magnetic storage devices, or any other non-transitory storage medium which may be used to carry or store desired program code in the form of computer-executable instructions or data structures and which may be accessed by a general-purpose or special-purpose computer. Combinations of the above may also be included within the scope of computer-readable media.

Computer-executable instructions comprise, for example, instructions and data, which cause a general-purpose computer, special-purpose computer, or special-purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module,” “component,” and/or “engine” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modules running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present invention have been described in detail, it should be understood that the various changes, substitutions, and alterations could be made hereto without departing from the spirit and scope of the invention.

What is claimed is:

1. A method of performing an electronic rental transaction, the method comprising:
obtaining, at a service provider server, an owner compliance from an owner device of an owner via a network;
receiving, at the service provider server, an asset rental request from a customer device for an asset of the owner;
comparing, by one or more processors, customer permissions to rental conditions, wherein the customer permissions include one or more information disclosures that are authorized by the customer and the rental conditions include information disclosures requested to rent the asset;
in response to the customer permissions matching at least all of the rental conditions, approving, by one or more processors, an electronic rental transaction; and
in response to the customer permissions matching less than all the rental conditions, preventing, by the one or more processors, the electronic rental transaction.

2. The method of claim 1, wherein the obtaining includes:
accessing, by the one or more processors, a local zone condition via the network;
notifying, by the one or more processors, the owner of the local zone condition for asset rental;
receiving a confirmation from the owner at the service provider server via the network;
determining, by the one or more processors, whether the owner confirms compliance with the local zone condition;
in response to a determination that the owner confirms compliance with the local zone condition, updating, by the one or more processors, a profile of the owner to reflect the confirmation of compliance with the local zone condition; and
in response to a determination that the owner does not confirm compliance with the local zone condition, suspending, by the one or more processors, a privilege of the owner to list the asset.

3. The method of claim 1, further comprising in response to the customer permissions matching less than the rental conditions, communicating to the customer device a message that requests authorization of one or more additional information disclosures such that the customer permissions match at least all of the rental conditions.

4. The method of claim 1, further comprising:
registering, by the one or more processors, a third party for participation in a sharing economy environment that includes the owner; and
in response to customer permissions matching at least all of the rental conditions, notifying the third party in accordance with the rental conditions via the network.

5. The method of claim 4, further comprising in response to customer permissions matching at least all of the rental conditions, notifying, by the one or more processors, a governmental entity in accordance with the rental conditions via the network.

6. The method of claim 4, wherein the registering includes:
notifying, by the one or more processors, the third party of an intention to list the asset of the owner using received contact details of the third party;
offering to the third party an option to receive information disclosure regarding the customer in response to execution of a rental transaction involving the asset; and
offering to the third party an option to receive secondary consideration that is a portion of a primary consideration exchanged for rental of the asset; and
in response to the third party opting in, registering, by the one or more processors, the third party,
wherein the contact details of the third party are input by the owner or a governmental entity.

7. The method of claim 1, further comprising
communicating, by the one or more processors, at least a portion of negotiations from the customer and to the owner and from the owner to the customer;
receiving, by the one or more processors, a primary consideration from the customer; and
transferring, by the one or more processors, to a third party a secondary consideration that is a portion of the primary consideration.

8. The method of claim 1, wherein the disclosures include:
transactional detail disclosure to a governmental entity;
customer profile information disclosure to a set of third parties based on one or more or a combination of a geographic proximity to the asset, ownership of the asset, management of the asset, on a common access point, and a membership related to the asset; and
a rental schedule disclosure to a set of third parties based on one or more or a combination of a geographic proximity to the asset, ownership of the asset, management of the asset, on a common access point, and a membership related to the asset.

9. The method of claim 1, further comprising confirming with the owner that a notification message is communicated to a third party.

10. The method of claim 1, wherein the asset includes a rental property, an automobile, a piece of equipment, or a boat.

11. A non-transitory computer-readable medium having encoded therein programming code executable by a processor to perform or control performance of operations comprising:
obtaining an owner compliance from an owner device of an owner via a network;
receiving an asset rental request from a customer device for an asset of an owner;
comparing customer permissions to rental conditions, wherein the customer permissions include one or more information disclosures that are authorized by the customer and the rental conditions include information disclosures requested to rent the asset;
in response to the customer permissions matching at least all of the rental conditions, approving an electronic rental transaction; and
in response to the customer permissions matching less than all the rental conditions, preventing the electronic rental transaction.

12. The non-transitory computer-readable medium of claim 11, wherein the obtaining includes:
accessing a local zone condition via the network;
notifying the owner of the local zone condition for asset rental;
receiving a confirmation from the owner at a service provider server via the network;
determining whether the owner confirms compliance with the local zone condition;
in response to a determination that the owner confirms compliance with the local zone condition, updating a profile of the owner to reflect the confirmation of compliance with the local zone condition; and
in response to a determination that the owner does not confirm compliance with the local zone condition, suspending a privilege of the owner to list the asset.

13. The non-transitory computer-readable medium of claim 11, wherein the operations further comprise in response to the customer permissions matching less than the rental conditions, communicating to the customer device a message that requests authorization of one or more additional information disclosures such that the customer permissions match at least all of the rental conditions.

14. The non-transitory computer-readable medium of claim 11, wherein the operations further comprise:
registering a third party for participation in a sharing economy environment that includes the owner; and
in response to customer permissions matching at least all of the rental conditions, notifying the third party in accordance with the rental conditions via the network.

15. The non-transitory computer-readable medium of claim 14, wherein the operations further comprise in response to customer permissions matching at least all of the rental conditions, notifying a governmental entity in accordance with the rental conditions via the network.

16. The non-transitory computer-readable medium of claim 14, wherein:
the registering includes:
notifying, by one or more processors, the third party of an intention to list the asset of the owner using received contact details of the third party;
offering to the third party an option to receive information disclosure regarding the customer in response to execution of a rental transaction involving the asset; and
offering to the third party an option to receive secondary consideration that is a portion of a primary consideration exchanged for rental of the asset; and
in response to the third party opting in, registering the third party; and
the contact details of the third party are input by the owner or a governmental entity.

17. The non-transitory computer-readable medium of claim 11, wherein the operations further comprise:
communicating at least a portion of negotiations from the customer and to the owner and from the owner to the customer;
receiving a primary consideration from the customer; and
transferring to a third party a secondary consideration that is a portion of the primary consideration.

18. The non-transitory computer-readable medium of claim 11, wherein the information disclosures include:
transactional detail disclosure to a governmental entity;
customer profile information disclosure to a set of third parties based on one or more or a combination of a geographic proximity to the asset, ownership of the asset, management of the asset, on a common access point, and a membership related to the asset; and
a rental schedule disclosure to a set of third parties based on one or more or a combination of a geographic proximity to the asset, ownership of the asset, management of the asset, on a common access point, and a membership related to the asset.

19. The non-transitory computer-readable medium of claim 11, wherein the operations further comprise confirming with the owner that a notification message is communicated to a third party.

20. The non-transitory computer-readable medium of claim 11, wherein the asset includes a rental property, an automobile, a piece of equipment, or a boat.
